(19) United States
(12) Patent Application Publication
(10) Pub. No.: US 2025/0067393 A1
(43) Pub. Date: Feb. 27, 2025

(54) TWO-PIECE BODY-WORN CAMERA

(71) Applicant: Digital Ally, Inc., Lenexa, KS (US)

(72) Inventors: Douglas C. Fletcher, Lake Winnebago, MO (US); Peng Han, Overland Park, KS (US)

(21) Appl. No.: 18/235,931

(22) Filed: Aug. 21, 2023

(51) Int. Cl. F16M 13/04; G03B 17/56; G03B 19/18; H04N 23/50; H04N 23/63

(52) U.S. Cl. CPC F16M 13/04; G03B 17/561; G03B 17/566; G03B 19/18; H04N 23/50; H04N 23/631

(57) ABSTRACT

Systems, devices, and methods are provided for a two-piece body-worn camera comprising a camera unit that may be docked into a docking unit. The camera unit may be a small form factor capture device that may be mounted to a user's body to capture video. Upon capturing video, the camera unit may be docked with the docking unit for recharging an internal battery and for the transfer of the captured video to the docking unit. Once transferred to the docking unit, the video can be wirelessly transferred to cloud-based storage for long-term storage.

### BACKGROUND

### 1. Field

Embodiments of the invention relate to a two-piece body-worn camera. More specifically, embodiments of the invention relate to a two-piece body-worn camera comprising a base unit and a removably attached head unit comprising a camera. The head unit may comprise a small form factor, allowing a user to capture video in an inconspicuous manner. After capturing video, the head unit may be docked to the base unit for uploading the captured video to cloud storage.

### 2. Related Art

Traditionally, when selecting body-worn cameras for on-duty recording, police officers and other law enforcement officers traditionally must choose between either larger, bulky body-worn cameras or smaller body-worn cameras with fewer capabilities. However, there are disadvantages inherent to each style. Large form factor body-worn cameras are bulky, can obstruct movement, and suffer from a lack of adequate attachment positions. For example, when attached to a front pocket of a shirt, the weight of a large form factor body-worn camera is likely to cause drooping of the camera, greatly reducing the field of view of the camera. Small form factor body-worn cameras, by contrast, suffer from limited battery size, lack of features, and network capabilities, making extended use impractical. Further, because of the limited form factor, small form factor body-worn cameras cannot include AI chipsets for advanced AI features.

Accordingly, what is needed is a body-worn camera that provides the benefits of an extended battery life and network capabilities of a large form factor and the attachment versatility provided by a small form factor.

### SUMMARY

In some aspects, the techniques described herein relate to a two-piece body-worn video camera including a docking unit including a docking bay, a display, a first internal battery, a first internal storage media, and a transceiver, wherein the docking unit includes a mounting assembly for mounting the docking unit to a first location on a body of a user; and a removable camera unit having a size that is configured to mount on the body of the user, including a camera, a second internal battery, and a second internal storage media, wherein the removable camera unit is selectively docked with the docking unit via the docking bay.

In some aspects, the techniques described herein relate to a two-piece body-worn video camera, wherein the removable camera unit is configured to store video data to video the second internal storage media when not docked with the docking unit.

In some aspects, the techniques described herein relate to a two-piece body-worn video camera, wherein the removable camera unit is configured to automatically transfer the video data stored on the second internal storage media to the first internal storage media when the removable camera unit is docked with the docking unit.

In some aspects, the techniques described herein relate to a two-piece body-worn video camera, wherein the docking unit further included a wireless transceiver operable to transfer the video data via an Internet connection to cloud-based storage.

In some aspects, the techniques described herein relate to a two-piece body-worn video camera, wherein the removable camera unit is configured to automatically display video data captured by the camera on the display of the docking unit when the removable camera unit is docked with the docking unit.

In some aspects, the techniques described herein relate to a two-piece body-worn video camera, wherein the docking unit is configured to transfer stored energy from the first internal battery of the docking unit to the second internal battery of the removable camera unit when the removable camera unit is attached to the docking unit.

In some aspects, the techniques described herein relate to a two-piece body-worn video camera, wherein the docking unit further included an additional camera integrated into the docking unit.

In some aspects, the techniques described herein relate to a two-piece body-worn camera system for recording and storing video of an event, including: a docking unit including: a docking bay, a first internal battery, a first internal storage media, a transceiver, and a first mounting assembly for mounting the docking unit to a first location on a body of a user, wherein the transceiver is configured to wirelessly couple the two-piece body-worn camera system to cloud-based storage; and a removable camera unit for capturing the video of the event, including: a camera, a second internal battery unit, a second internal storage media, and a second mounting assembly for mounting the removable camera unit to a second location on the body of the user, wherein the docking bay is configured to receive the removable camera unit, wherein the removable camera unit is configured to transfer the video of the event from the second internal storage media of the removable camera unit to the first internal storage media of the docking unit when the removable camera unit is docked with the docking unit.

In some aspects, the techniques described herein relate to a two-piece body-worn camera system, wherein the docking unit is configured to transfer the video of the event to the cloud-based storage.

In some aspects, the techniques described herein relate to a two-piece body-worn camera system, wherein the video of the event includes video data for a predetermined period of time prior to the user actuating an input to instruct recording by the two-piece body-worn camera system.

In some aspects, the techniques described herein relate to a two-piece body-worn camera system, wherein the removable camera unit includes an additional transceiver operable to wirelessly couple the removable camera unit to at least one of the docking unit or the cloud-based storage.

In some aspects, the techniques described herein relate to a two-piece body-worn camera system, wherein the docking unit further includes an additional camera for capturing additional video of the event.

In some aspects, the techniques described herein relate to a two-piece body-worn camera system, wherein the removable camera unit further includes a microphone for capturing audio.

In some aspects, the techniques described herein relate to a two-piece body-worn camera system, wherein the camera is operable to record video data at a resolution of at least 1080p and at a frame rate of at least 30 frames per second.

In some aspects, the techniques described herein relate to a method of capturing video using a two-piece body-worn camera system, the method including: responsive to detecting an actuation of an input by a user, capturing video data of an event by a camera of a removable camera unit, wherein the removable camera unit is undocked from a docking unit when the actuation is detected, wherein the removable camera unit and the docking unit are separately mounted on a body of the user when the actuation is detected; storing the video data by the removable camera unit in a first internal storage medium of the removable camera unit; responsive to detecting that the removable camera unit has been docked on the docking unit: transferring the video data of the event to a second internal storage medium of the docking unit; and transferring stored electrical energy from a first internal battery of the docking unit to a second internal battery of the removable camera unit; and subsequent to the event, transferring the video from the second internal storage medium of the docking unit to cloud-based storage via a wireless network transceiver.

In some aspects, the techniques described herein relate to a method, further including displaying the video data on a display of the docking unit during the event.

In some aspects, the techniques described herein relate to a method, further including responsive to a determination that the video was successfully transmitted to the cloud-based storage, displaying a transfer confirmation a display of the docking unit.

In some aspects, the techniques described herein relate to a method, further including deleting the video data from at least one of the first internal storage medium and the second internal storage medium responsive to the determination.

In some aspects, the techniques described herein relate to a method wherein the second internal storage medium has a greater storage capacity than the first internal storage medium, and the first internal battery has a greater energy capacity than the second internal battery of the removable camera unit.

In some aspects, the techniques described herein relate to a method wherein the removable camera unit is configured to continue to capture and store the video data when the removable camera unit is docked with the docking unit during the event.

### BRIEF DESCRIPTION OF THE DRAWING FIGURES

Embodiments of the invention are described in detail below with reference to the attached drawing figures, wherein:

FIG. 1 depicts an exemplary hardware platform for certain embodiments of the invention;

FIG. 2 depicts an exemplary system configuration for certain embodiments of the invention;

FIG. 3 depicts a perspective view of a two-piece body-worn camera in a docked configuration for certain embodiments of the invention;

FIG. 4A depicts a front perspective view of a detachable camera unit of a two-piece body-worn camera for certain embodiments of the invention;

FIG. 4B depicts a rear perspective view of a detachable camera unit of a two-piece body-worn camera for certain embodiments of the invention;

FIG. 4C depicts a bottom perspective view of a removable camera unit of a two-piece body-worn camera for certain embodiments of the invention;

FIG. 5A depicts a front perspective view of a docking unit of a two-piece body-worn camera for certain embodiments of the invention;

FIG. 5B depicts a front perspective view of a docking unit of a two-piece body-worn camera for certain embodiments of the invention;

FIG. 6A depicts an exemplary use case of a patrol officer using a two-piece body-worn camera in an undocked configuration;

FIG. 6B depicts an exemplary use case of a patrol officer using a two-piece body-worn camera in a docked configuration; and

FIG. 6C depicts an exemplary use case of a patrol office using a two-piece body-worn camera in an undocked configuration with an optional cabled.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc., described in one embodiment may also be included in other embodiments but is not necessarily included. Thus, the technology can include a variety of combinations and/or integrations of the embodiments described herein.

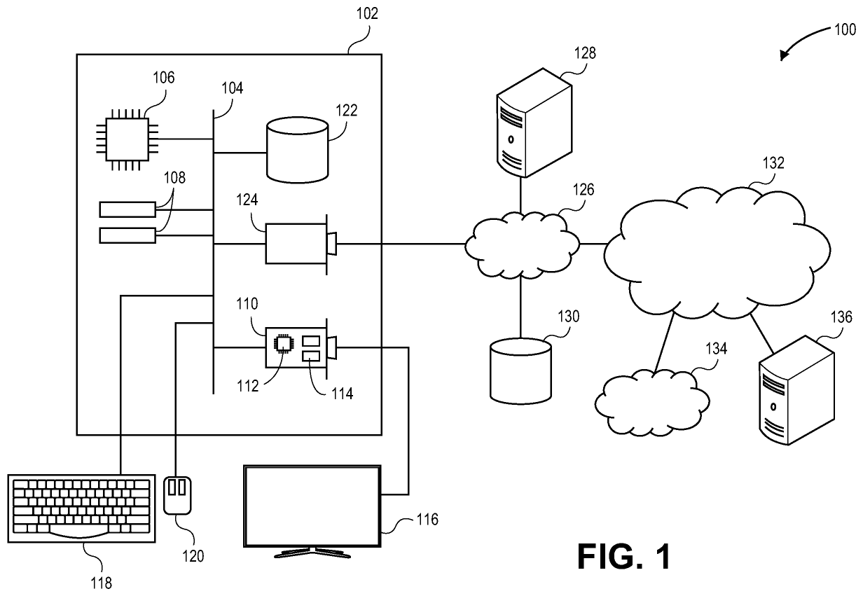

Turning first to FIG. 1, an exemplary hardware platform for certain embodiments of the invention is depicted. Computer 102 can be a desktop computer, a laptop computer, a server computer, a mobile device such as a smartphone or tablet, or any other form factor of general- or special-purpose computing device. Depicted with computer 102 are several components for illustrative purposes. In some embodiments, certain components may be arranged differently or absent. Additional components may also be present. Included in computer 102 is system bus 104, whereby other components of computer 102 can communicate with each other. In certain embodiments, there may be multiple buses or components that may communicate with each other directly. Connected to system bus 104 is central processing unit (CPU) such as CPU 106. Also attached to system bus 104 are one or more random-access memory (RAM) module 108. Also attached to system bus 104 is graphics card 110. In some embodiments, graphics card 110 may not be a physically separate card but rather may be integrated into the motherboard or the CPU 106. In some embodiments, graphics card 110 has a separate graphics-processing unit (GPU) 112, which can be used for graphics processing or for general-purpose computing (GPGPU). Also on graphics card 110 is GPU memory 114. Connected (directly or indirectly) to graphics card 110 is display 116 for user interaction. In some embodiments, no display is present, while in others, it is integrated into computer 102. Similarly, peripherals such as keyboard 118 and mouse 120 are connected to system bus 104. Like display 116, these peripherals may be integrated into computer 102 or absent. Also connected to system bus 104 is local storage 122, which may be any form of computer-readable media and may be internally installed in computer 102 or externally and removably attached.

Computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical but transitory forms of signal transmission such as radio broadcasts, electrical signals through a wire, or light pulses through a fiber-optic cable. Examples of stored information include computer-useable instructions, data structures, program modules, and other data representations.

Finally, network interface card (NIC) 124 is also attached to system bus 104 and allows computer 102 to communicate over a network such as local network 126. NIC 124 can be any form of network interface known in the art, such as Ethernet, ATM, fiber, Bluetooth®, or Wi-Fi (i.e., the IEEE 802.11 family of standards). NIC 124 connects computer 102 to local network 126, which may also include one or more other computers, such as computer 128, and network storage, such as data store 130. Generally, a data store such as data store 130 may be any repository from which information can be stored and retrieved as needed. Examples of data stores include relational or object-oriented databases, spreadsheets, file systems, flat files, directory services such as LDAP and Active Directory, or email storage systems. A data store may be accessible via a complex API (such as, for example, Structured Query Language), a simple API providing only read, write, and seek operations, or any level of complexity in between. Some data stores may additionally provide management functions for data sets stored therein, such as backup or versioning. Data stores can be local to a single computer, such as computer 128, accessible on a local network, such as local network 126, or remotely accessible over Internet 132. Local network 126 is, in turn, connected to Internet 132, which connects many networks such as local network 126, remote network 134, or directly attached computers such as computer 136. In some embodiments, computer 102 can itself be directly connected to Internet 132.

### System Architecture

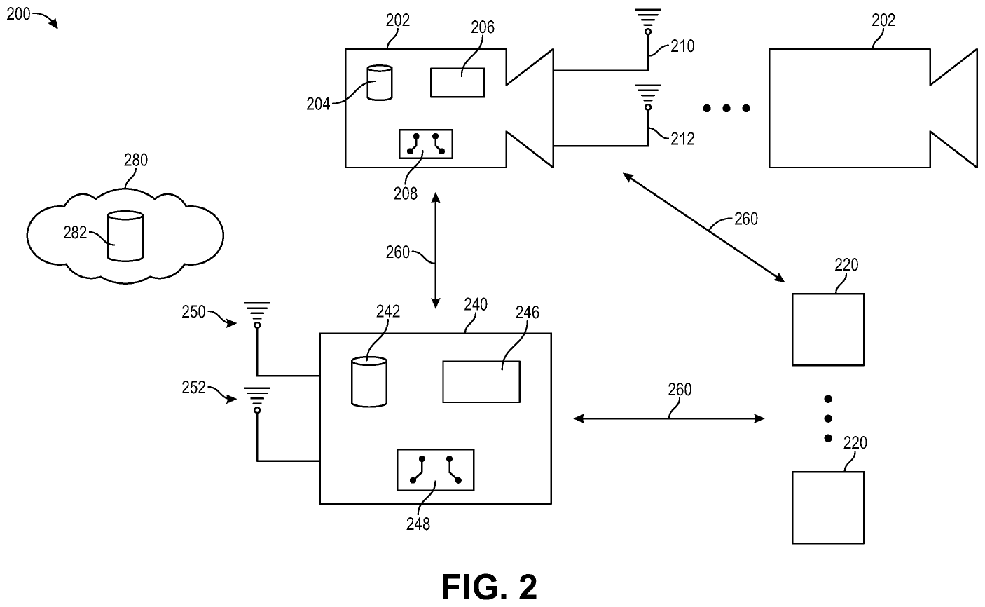

FIG. 2 depicts one example of a video recording system 200 relating to some embodiments of the invention. Broadly, video recording system 200 comprises one or more cameras, such as lightweight camera 202. In various embodiments, these cameras may comprise any combination of video cameras, still cameras, and microphones. For example, video recording system 200 may comprise a plurality of cameras operable to record both video and audio data.

In some embodiments, at least some instances of lightweight camera 202 comprise an internal storage media 204, as shown. Accordingly, the internal storage media 204 of lightweight camera 202 may be configured to store video data captured by the respective camera. For example, internal storage media 204 may include flash memory, RAM, or any other non-transitory computer-storage medium.

In further embodiments, at least some instances of lightweight camera 202 comprise an internal battery 206 configured to provide power to the camera during use. In some embodiments, internal battery 206 may be a permanently situated battery. In other embodiments, internal battery 206 may be a replaceable battery. Broadly, any type of battery technology now known or later developed is contemplated for use with embodiments of the invention, including alkaline batteries, nickel-cadmium (NiCd) batteries, lithium-ion (Li-ion) batteries, Lithium-polymer (Li-poly) batteries, or any other type of rechargeable or non-rechargeable battery.

In some embodiments, at least some instances of lightweight camera 202 comprise a processor 208. In such embodiments, processor 208 may be configured to control the operation of the respective camera. For example, processor 208 may monitor data captured from the respective camera to instruct storage of data on the internal storage media 204. Alternatively, or in addition, processor 208 may monitor a signal received from one or more sensors or other components of video recording system 200 to determine a triggering event. For example, processor 208 may trigger recording in response to a signal received from an audio gunshot sensor.

In some embodiments, video recording system 200 may be provided with a pre-event recording mode whereby the video recording system 200 records constantly in a circular buffer that stores video corresponding to a predetermined duration of time, such as thirty seconds or sixty seconds. Upon a triggering event occurring, as described below, the lightweight camera 202 may save the recorded video corresponding to the predetermined duration of time preceding the triggering signal (here, the thirty- or sixty-second segment of captured video occurring prior to the triggering event). In response to a triggering event, the processor 208 may cause lightweight camera 202 to begin recording and/or to save the pre-event recording to internal storage media 204.

Examples of a triggering event may include, for example, a user actuating an input to instruct recording by the lightweight camera 202, removing a camera unit from a docking unit, a position of a vehicle and/or officer as measured by a GPS, a vehicle crash event or vehicle attaining a threshold speed (e.g., 80 m.p.h.), or a sensor such as sensor 220 registering a predetermined input (e.g., a determination that a gunshot has occurred). In some embodiments, video recording system 200 may additionally process video data from lightweight camera 202 as an additional source of triggering events. For example, in some embodiments, video recording system 200 may include facial detection software that detects if the face of a person is in view of lightweight camera 202. Thus, for example, if a person is in view of one or more instances of lightweight camera 202 for a predetermined length of time (for example, for more than 30 seconds), the system may infer that the user of video recording system 200 is having an interaction with the person and instruct camera to begin saving video.

In some embodiments, at least some instances of lightweight camera 202 comprise a cellular transceiver 210. In such embodiments, the cellular transceiver 210 comprises a radio transceiver for communicating (for example, with a cloud storage server) via a cellular data connection. Alternatively, or in addition, in some embodiments, the lightweight camera 202 comprises a Wi-Fi transceiver 212 for communicating over an 802.11 (Wi-Fi) network. Broadly, video recording system 200 may utilize cellular transceiver 210 and Wi-Fi transceiver 212 preferentially (for example, communicating via Wi-Fi if a Wi-Fi network is available and via cellular data otherwise) or in concert.

In some embodiments, video recording system 200 further comprises one or more sensors, such as sensor 220. In some embodiments, sensor 220 comprises any of a radio frequency identifier (RFID) tag reader, an accelerometer, a global positioning system (GPS) receiver, a motion sensor, an acoustic sensor, a pressure sensor, a temperature sensor, or any other suitable type of sensor. Embodiments are contemplated where sensor 220 is incorporated into lightweight camera 202. For example, in some embodiments, sensor 220 comprises an RFID tag reader disposed on or within lightweight camera 202. In other embodiments, sensor 220 may be incorporated into the docking and managing unit, as described below.

In some embodiments, each lightweight camera 202 may have a unique identifier, identifying each camera uniquely and/or as distinct from each other cameras of one or more instances of video recording system 200. For example, as described in greater detail below, lightweight camera 202 may be paired with a portable dock unit 240 in order to transfer captured video files from the lightweight camera 202 to the portable dock unit 240 for subsequent storage and/or upload. Further, a portable dock unit 240 may be paired with coupled to many different instances of lightweight camera 202 over time and vice versa. Accordingly, each instance of lightweight camera 202 may be provided with a unique identifier, such that the portable dock unit 240 may distinguish between each different instance of lightweight camera 202 coupled to portable dock unit 240 and thereby associate video data from lightweight camera 202 with metadata for identifying lightweight camera 202. In some embodiments, the unique identifier may be readable by sensor 220. For example, lightweight camera 202 may be provided with an RFID tag storing the unique identifier of lightweight camera 202 and readable by an RFID tag reader of the portable dock unit 240.

In some embodiments, at least some instances of lightweight camera 202 and/or portable dock unit 240 comprise an integrated GPS receiver (not shown) connected to a GPS antenna (not shown). Utilizing the information provided by these components, video recording system 200 may mark recorded video with real-time geolocation data indicating a geographic location where video data was recorded. In some such embodiments, video recording system 200 may additionally include a dead reckoning function that works with GPS to allow for geolocation in shielded locations, such as underground garages. In some embodiments, geolocation is stored as metadata for the video data. In other embodiments, geolocation data is superimposed on recorded video data.

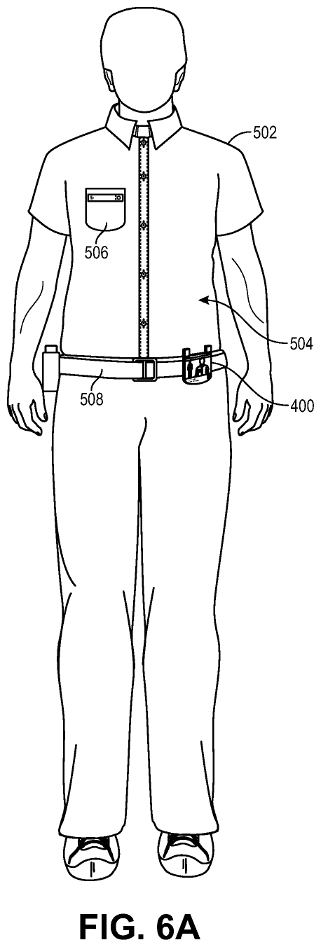

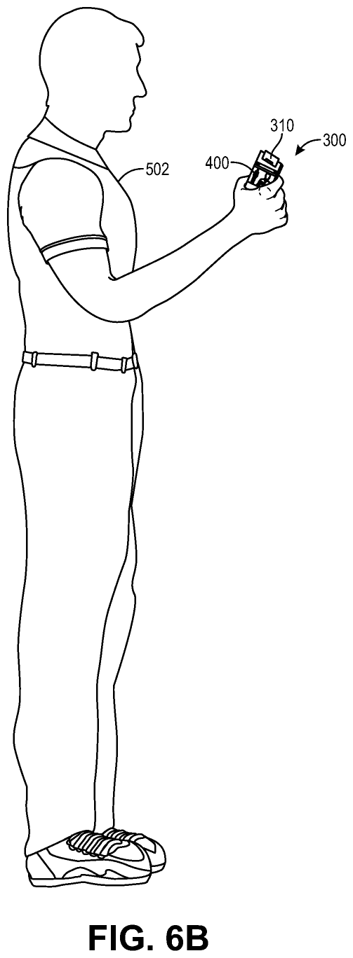

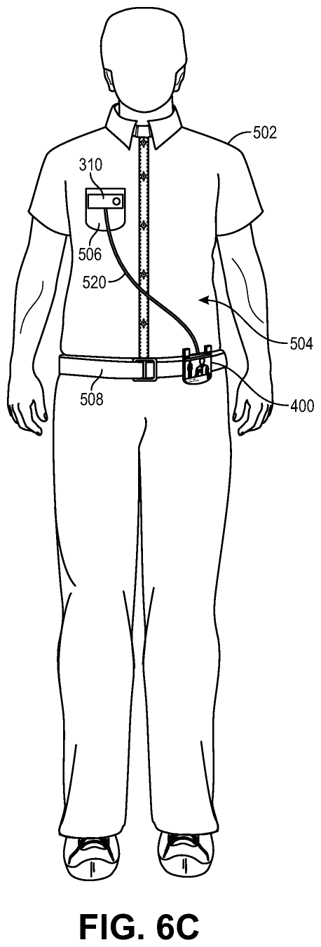

As described above, in some embodiments, video recording system 200 comprises a portable dock unit 240 for use with lightweight camera 202. As described below, it is contemplated that both of lightweight camera 202 and portable dock unit 240 are worn on the body of the user. In some applications, lightweight camera 202 may be docked in portable dock unit 240 during use to make use of the greater storage capacity and larger battery of portable dock unit 240. In other applications, lightweight camera 202 may be mounted on the user's body separately from the portable dock unit 240 to utilize a mounting point unsuited to the greater size and weight of portable dock unit 240. For example, as shown in FIGS. 6A and 6C, lightweight camera 202 may be mounted via a pocket mount, while portable dock unit 240 may be mounted via a belt mount. In some such separate mounting applications, lightweight camera 202 may be physically connected to portable dock unit 240 (for example, via a cable as shown in FIG. 6C) to provide charging and data transfer. In other such separate mounting applications, lightweight camera 202 can be wirelessly connected to portable dock unit 240 to provide data transfer only while removing the need for a connecting cable. In still other such separate mounting applications, lightweight camera 202 operates independently from portable dock unit 240 until such time it is physically docked with portable dock unit 240. In yet other separate mounting applications, lightweight camera 202 operates independently from portable dock unit 240 until internal storage media 204 runs low on free space, at which time lightweight camera 202 automatically communicates with portable dock unit 240 to transfer stored data and free up space on internal storage media 204.

Accordingly, in some embodiments, the portable dock unit 240 may be communicatively coupled to the lightweight camera 202 and/or to the one or more sensors, such as sensor 220 through connection 260. In some such embodiments, connection 260 may be any combination of wired and wireless communication connections. For example, connection 260 may be a BLUETOOTH® wireless connection established between lightweight camera 202 and the portable dock unit 240. Alternatively, in some embodiments, connection 260 may be a wired connection, such as a USB or Ethernet connection between the portable dock unit 240 and the lightweight camera 202. Broadly, the connection 260 between the portable dock unit 240 and the lightweight camera 202 allows for video data captured from the lightweight camera 202 to be transmitted to the portable dock unit 240 and control signals to be communicated from the portable dock unit 240 to the lightweight camera 202. Further, embodiments are contemplated in which control signals may additionally be transmitted from the lightweight camera 202 to the portable dock unit 240. Accordingly, connection 260 may be configured as a bidirectional communication connection between the portable dock unit 240 and the lightweight camera 202. In some embodiments, a connection 260 may also exist between the one or more sensors, such as sensor 220 and portable dock unit 240.

In some embodiments, the portable dock unit 240 comprises storage media 242. For example, storage media 242 may be larger (physically and in storage capacity) than internal storage media 204. In some such embodiments, the storage media 242 is configured to store video data captured by lightweight camera 202 and any related metadata. In some embodiments, storage media 242 may be removable from the portable dock unit 240. For example, the storage media 242 may comprise a removable USB flash memory device, an SD card, or the like, such that storage media 242 may be used to physically transfer the contents of the storage media 242 (such as video data captured lightweight camera 202) to an external data store. In other embodiments, storage media 242 may be permanently disposed within the portable dock unit 240.

In some embodiments, the portable dock unit 240 comprises a battery 246. For example, battery 246 may be larger (physically and in energy capacity) than internal battery 206. Battery 246 may be configured to provide power to portable dock unit 240 when in use. As described in greater detail below, battery 246 may further be configured to provide power to internal battery 206 of the lightweight camera 202 (for example, to recharge internal battery 206 when it is depleted) and/or provide power to lightweight camera 202 directly. For example, the internal battery 206 of lightweight camera 202 may become depleted during the course of a patrol officer's shift. In order to continue to use lightweight camera 202 to capture video (and concurrently recharge internal battery 206 for continued use) may be operatively coupled to portable dock unit 240, and power from battery 246 may be transferred to charge internal battery 206 and concurrently provide power to lightweight camera 202 for continued use.

In some embodiments, the portable dock unit 240 further comprises a processor 248 configured to control the operation of the portable dock unit 240. For example, processor 248 may monitor data received from the lightweight camera 202 and/or sensor 220 to determine instructions to be sent to the lightweight camera 202, to instruct storage of data on storage media 242, or to perform other functions. In some embodiments, processor 248 further communicates with processor 208 of each of lightweight camera 202 for sending commands or instructions to the respective one of lightweight camera 202. In some embodiments, the processor 248 monitors a signal received from sensor 220 to determine a triggering event. For example, in some embodiments, sensor 220 may provide a signal including a triggering event indication which initiates a triggering event procedure of video recording system 200.

In some embodiments, like lightweight camera 202, the portable dock unit 240 may have a unique identifier. For example, in an exemplary use case, the portable dock unit 240 may be used by a law enforcement officer for recording events that occur during a shift. Where multiple law enforcement officers respond to an event, it may be advantageous to know the identity of the portable dock unit 240 that was used by each law enforcement officer. Accordingly, it may be desirable for the portable dock unit 240 to have a unique identifier for record-keeping or chain-of-custody purposes. In some embodiments, the unique identifier may be associated with sensor 220, such as an RFID tag reader. In some embodiments, the unique identifier may be associated with metadata for identifying each portable dock unit 240.

In some embodiments, the portable dock unit 240 further comprises an integrated camera. In some such embodiments, this integrated camera begins recording automatically when lightweight camera 202 is removed from portable dock unit 240. In other embodiments, this integrated camera records continuously regardless of whether lightweight camera 202 is docked or undocked. In some embodiments, this integrated camera is configured to capture different imagery than lightweight camera 202 when docked. For example, the integrated camera may include a wide-angle lens or be oriented in a different direction than the camera of lightweight camera 202 when docked.

In some embodiments, the portable dock unit 240 further comprises a display screen. In some such embodiments, this display screen is configured to continuously (or on-demand) display imagery being captured by lightweight camera 202 or by a camera integrated into portable dock unit 240. In some such embodiments, this display screen is operable to display previously captured imagery (for example, such that a user can review recent footage). In some other embodiments, this display screen is operable to display imagery transmitted wirelessly by an arbitrary one of lightweight camera 202 in order to function as a remote viewing platform.

In some embodiments, the portable dock unit 240 further comprises a wireless transceiver 250 that may be internal or external to the portable dock unit 240. Additionally, in some embodiments, the portable dock unit 240 comprises a Wi-Fi transceiver 252 configured to wirelessly transmit and receive Wi-Fi signals over a network that may be internal or external to the portable dock unit 240. Embodiments are contemplated in which either the wireless transceiver 250 or the Wi-Fi transceiver 252 may be used to establish communication with the lightweight camera 202 and/or the sensor 220 via connection 260. Alternatively, or additionally, in some embodiments, as described above, the lightweight camera 202 and the sensor 220 may be communicatively coupled via a wired connection. Further still, one or more additional dedicated wireless transceivers may be included to communicate with the lightweight camera 202.

In some embodiments, the wireless transceiver 250 and/or the Wi-Fi transceiver 252 are operable to communicate with a cloud-based storage system 280. In some embodiments, the cloud-based storage system 280 comprises a cloud data store 282, as shown, for remotely storing data. As such, embodiments are contemplated in which video data captured by the lightweight camera 202 is transmitted to the cloud-based storage system 280 and stored in the cloud data store 282. For example, in some embodiments, it may be desirable to store the video data within the cloud data store 282 to provide a redundant copy of the video data in the event of the physical destruction of the portable dock unit 240 and/or the lightweight camera 202. In some such embodiments, the video data may be transmitted to the cloud-based storage system 280, for example, by using the Wi-Fi transceiver 252 to transmit the video data over a wireless network.

In further embodiments, the lightweight camera 202 of video recording system 200 may optionally or additionally be in communication with cloud-based storage system 280 via cellular transceiver 210 and/or Wi-Fi transceiver 212. Accordingly, in some embodiments, information, video, or other data may be directly transferred from lightweight camera 202 to cloud-based storage system 280 instead of or in addition to via portable dock unit 240. For example, as described in greater detail below, certain use cases of the present teachings may be used by law enforcement personnel. In certain situations, it may be advantageous or desirable for a law enforcement officer to transmit video directly from lightweight camera 202 to cloud-based storage system 280. For example, if portable dock unit 240 becomes damaged, the law enforcement officer may be able to upload video directly from lightweight camera 202.

In some embodiments, video captured by the lightweight camera 202 may contain sensitive information or data being exchanged between lightweight camera 202, portable dock unit 240, and cloud-based storage system 280. Accordingly, in some embodiments, information, media, and/or data exchanged in video recording system 200 may be encrypted, such that data is written to them encrypted using an encryption key (which can correspond to devices or components of video recording system 200, a user, or be unique in some other way) and cannot be accessed unless decrypted with a corresponding decryption key.

### Exemplary Hardware Embodiments of the Invention

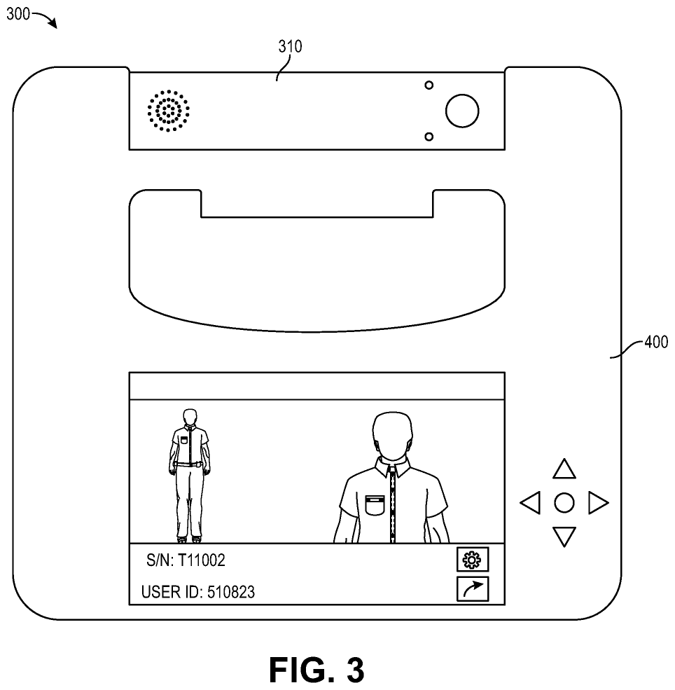

FIG. 3 depicts an exemplary embodiment of a two-piece body-worn camera 300. Broadly, embodiments of the present teachings are directed to a two-piece body-worn camera 300 comprising a lightweight camera unit that may be docked into a portable dock unit. As described in greater detail below, embodiments of the present teachings provide for a body-worn camera that combines the flexibility of a small form factor camera that may be mounted in a variety of positions on a user's body with a large form factor base unit that provides increased battery life, a display, network capabilities, among other advantages.

In embodiments of the present teachings, the two-piece body-worn camera 300 may be advantageous for use by law enforcement personnel during an event, such as approaching a suspect or performing an arrest. Law enforcement personnel routinely encounter physically demanding activities and other rigors. Accordingly, a small form factor camera unit may be advantageous for attachment to a front shirt pocket or other forward positioning on the wearer's body to capture video, allowing the law enforcement personnel to perform such actions while still capturing video. When designing cameras to comprise ever-reduced form factors, a balance is considered between an overall form factor while also accounting for battery size and other features and functionality. For example, a patrol officer may be on duty for eight or more hours, and a camera must have enough battery life to capture the entirety of the patrol officer's shift. To account for this delicate balance, embodiments of the present teachings are adapted to provide a docking unit that the camera unit may be placed into, which may allow for the transferring of video files, charging of the camera unit, transmitting data to cloud storage, and other advantages. Accordingly, embodiments of the present teachings provide a two-piece body-worn camera 300 comprising a camera unit 310 removable for docking in, securing to, and/or attaching with a docking unit 400. As described in greater detail, camera unit 310 may be communicatively coupled to docking unit 400 through either a wired and/or wireless means. Through such communicative coupling, communication, instructions, or other data may be transferred from docking unit 400 to camera unit 310 and/or vice versa.

Although embodiments of the present teachings are adapted for law enforcement personnel, it should be appreciated that the present teachings can be used by any user desiring to record events and are not intended to be limited to just law enforcement personnel. Further, it will be appreciated that embodiments of the present teachings may be used in other applications, including but not limited to dashboard cameras for vehicles, mounted camera operations, and other applications.

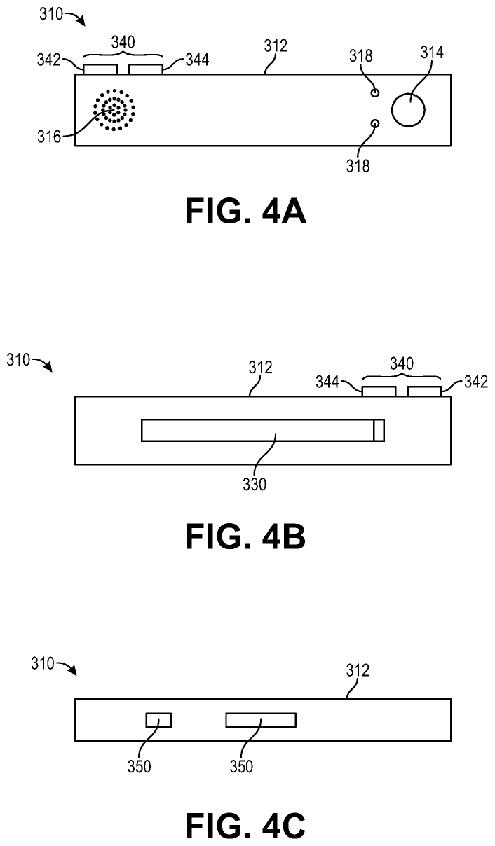

Turning now to FIGS. 4A-C, an exemplary embodiment of a camera unit 310 of two-piece body-worn camera 300 is depicted. Generally, camera unit 310 is configured to capture video, still images, and/or audio (individually or collectively, “video”) and to transmit the captured video to the docking unit 400 for storage on a storage medium of the docking unit and/or for transmitting the captured video to cloud storage. As described in greater detail below, camera unit 310 may be configured to operate as a singular video capture device, capable of independently capturing video when separated from docking unit 400. Accordingly, camera unit 310 may comprise one or more parts or components for capturing, storing, and/or transmitting video. Through such a configuration, camera unit 310 may be used to capture video with a small form factor camera, providing for discrete or covert applications. In further embodiments, camera unit 310 may act in cooperation with docking unit 400, as described in greater detail below. Accordingly, in some embodiments, camera unit 310 may comprise one or more parts or components configured for cooperating with docking unit 400.

Camera unit 310 comprises a camera housing 312, providing the structural body to camera unit 310 and housing one or more parts, components, circuitry, and/or features of camera unit 310. As described in greater detail below, in some embodiments, camera unit 310 may be selectively removable from docking unit 400 for placement on the body of a wearer. Accordingly, in some embodiments, camera housing 312 may be designed as having a form factor configured for the placement of camera unit 310 on a wearer's body. In certain applications, such as for security officers, law enforcement offices, or other applications in which concealment or discretion of a camera may be desirable, camera housing 312 may comprise a relatively small form factor. For example, camera housing 312 may comprise a width of approximately 0.25 inches to approximately 5 inches, approximately 0.5 inches to approximately 4 inches, approximately 0.75 inches to approximately 3 inches, or approximately 1.125 inches. Camera housing 312 may comprise a height of approximately 0.5 inches to approximately 5 inches, approximately 0.75 inches to approximately 4 inches, approximately 1.25 inches to approximately 3 inches, or approximately 1.5 inches. Camera housing 312 may comprise a depth (excluding the lens, one or more sensors, or other extending parts or components attached to or connected with camera housing 312) of approximately 0.15 inch to approximately 1 inch, approximately 0.25 inch to approximately 0.90 inches, approximately 0.35 inch to approximately 0.75 inches, or approximately 0.5 inches. Additionally, in some embodiments, the camera housing 312 may weigh less than or equal to 5 ounces, less than or equal to 3 ounces, less than or equal to 1 once, or approximately 0.8 ounces.

In some embodiments, camera housing 312 may be constructed from acrylonitrile butadiene styrene (ABS) or other thermoplastic polymer material, or other lightweight, durable material. For example, it is envisioned that two-piece body-worn camera 300 may be utilized by law enforcement officers to capture video. Accordingly, two-piece body-worn camera 300 may be exposed to situations and circumstances that could be hazardous to non-durable material. For example, in the apprehension of a suspect, a law enforcement officer may have to engage with the suspect, creating the possibility of force being applied to camera unit 310. Accordingly, camera unit 310 may need to be constructed from a durable material to withstand forces that a law enforcement officer may encounter. Further, for weatherproofing or weather-resistant properties, camera housing 312 may be covered with a neoprene coating or other similar material, providing a water-resistant effect to camera unit 310. As described above, two-piece body-worn camera 300 may be used by law enforcement officers who often work in inclement weather. Accordingly, camera unit 310 may be covered or coated with neoprene or other material to protect camera unit 310 from rain, wind, or other weather.

Even further, in some embodiments, camera housing 312 may comprise additional coatings or may be designed in such a way that provides a camouflaging effect or otherwise assist in making camera unit 310 inconspicuous to a third-party observer. By way of a non-limiting example, camera housing 312 may be designed to look like a name tag for positioning on the chest of the wearer. Accordingly, camera housing 312 may be lined with a metallic coating, providing additional effect to the disguise of camera unit 310. In further embodiments, camera housing 312 may comprise a coating for blending into the clothes of the wearer. For example, a patrolling officer may wear a navy-blue uniform, and camera housing 312 may comprise a navy-blue coating for blending camera unit 310 with the patrolling officer's uniform.

Camera unit 310 generally includes image and audio capture components and circuitry, such as a camera 314 and a microphone 316. Camera 314 may comprise a lens, providing for the capture of video. Camera 314 may be any known or yet-to-be-developed camera. For example, in some embodiments, camera 314 may comprise varying lenses configured for capturing video in varying conditions, light levels, resolution, etc., including but not limited to prime lenses, zoom lenses, macro lenses, telephoto lenses, wide-angle lenses, standard lenses, or specialty lenses such as fish-eye lenses or infrared lenses. In some embodiments, camera unit 310 may optionally and/or additionally comprise one or more sensors such as sensors 318, to aid in capturing video in a variety of applications or settings. For example, law enforcement officers often work in sub-optimal conditions, including at night or in inclement weather. Accordingly, camera unit 310 may comprise sensors 318 to aid in capturing video in such conditions. Sensors 318, for example, may be an image sensor operable to capture video in HD and in low light at a minimum lux of at least 0.0687 lux. Sensors 318 may further be light emitters for emitting a frequency of light to aid in the capture of video, serving to aid in capturing in low-light scenarios. Camera 314 may have the following field of view: horizontal, 97 degrees; vertical, 70 degrees; and diagonal, 136 degrees. In some embodiments, camera 314 is operable to record at a resolution of at least 1080p video or more and at a frame rate of at least 30 frames per second or more. Moreover, encoded, captured video may be viewed on standardized video-viewing software. It should be appreciated that other image sensors and lenses could be employed in embodiments of the invention.

In some embodiments, camera unit 310 may comprise additional components, such as a memory element, a battery element, and other components. Camera unit 310 may comprise any and all of the components described above with respect to lightweight camera 202 with reference to FIG. 2. For example, camera unit 310 may comprise at least an internal battery 206 and an internal storage media 204. In some embodiments, the internal battery 206 and internal storage media 204 may be located entirely within the dimensions of camera housing 312. In some embodiments, the internal battery 206 and internal storage media 204 may be located at least partially outside the dimensions of camera housing 312. For example, internal battery 206 may be a removable battery that may be attached to an outside portion of camera housing 312. As described herein, camera unit 310 may be selectively removable from docking unit 400 for placement on the body of a wearer. Accordingly, because camera unit 310 comprises an internal battery 206 and internal storage media 204, camera unit 310 may capture and store video when separated from docking unit 400. For example, during a covert operation, camera unit 310 may be removed from docking unit 400 and placed on a wearer's body. Due to the low profile of camera unit 310, a wearer may discreetly record an event.

As described in greater detail below, camera unit 310 may be docked or otherwise attached to docking unit 400, such as for storage or transport. In some embodiments, camera unit 310 may not be powered by the internal battery 206 unless camera unit 310 is detached from docking unit 400. When detached, camera unit 310 may be powered on or otherwise operational with power derived from internal battery 206. In some embodiments, internal battery 206 may power the camera unit 310 for approximately 30 minutes, for approximately 45 minutes, for approximately 60 minutes, for approximately 90 minutes, for approximately 120 minutes, for approximately 180 minutes, or for approximately 240 minutes. In some embodiments, the duration that camera unit 310 may be powered on for when relying on internal battery 206 may be determined, at least in part, by the features that camera unit 310 is utilizing. For example, if camera unit 310 is in standby mode or is not actively recording video, internal battery 206 may provide camera unit 310 approximately 4 hours of power. However, if camera unit 310 is actively recording video and thereby consuming more energy, then internal battery 206 may provide camera unit 310 with approximately 2 hours of power.

It will also be appreciated that the time that camera unit 310 may be powered on may be based, at least in part, on the size of internal battery 206 and the amount of electric power that may be stored by the internal battery 206. For example, when considering the amount of time that camera unit 310 may be in a powered-on state, the size of internal battery 206 and the overall size of camera housing 312 may be considered. For example, in certain scenarios, such as covert operations, discretionary placement of camera unit 310 may be more desirable than extended battery life. Accordingly, in such a scenario, camera unit 310 may comprise a relatively small form factor and an internal battery 206 of smaller capacity providing approximately 30 minutes of power. However, in certain scenarios, such as patrolling of a uniformed police officer, camera unit 310 may be placed out in the open or otherwise with less emphasis on discretion, and camera unit 310 may comprise a relatively large form factor and an internal battery 206 of larger capacity providing approximately 3 hours of power. Accordingly, the amount of time that camera unit 310 may be in a powered-on state may be at least determined by the size of camera housing 312 and/or internal battery 206, which may be determined at least in part by the intended application of camera unit 310.

As described above, camera unit 310 may be detached from docking unit 400 and placed on the body of a wearer for recording video via camera 314. Accordingly, in some embodiments, camera unit 310 may comprise a storage media for the storing of recorded video captured by camera 314. In some embodiments, the storage media may be internal storage media 204 as described above with respect to FIG. 2. Using the above-described methods, video may be captured from camera 314 and stored locally on internal storage media 204. Accordingly, camera unit 310 may be detached from docking unit 400, secured to the body of a wearer, capture video, and store video locally on internal storage media 204.

Like internal battery 206, the storage capabilities of internal storage media 204 may be dependent on numerous factors, including the size of camera housing 312 and/or the size of internal storage media 204. Accordingly, internal storage media 204 may be configured with varying storage capabilities. By way of non-limiting example, internal storage media 204 may provide approximately 4 GB of storage, approximately 8 GB of storage, approximately 16 GB of storage, approximately 32 GB of storage, approximately 64 GB of storage, approximately 128 GB of storage, or approximately 256 GB of storage.

As described in greater detail below, video captured by camera unit 310 may be uploaded or transmitted to a cloud storage or other external storage media. In further embodiments, camera unit 310 may be wirelessly coupled to another device, including docking unit 400. Accordingly, in some embodiments, camera unit 310 may optionally or additionally comprise one or more transceivers for wireless communication. For example, in some embodiments, camera unit 310 may optionally or additionally comprise a wireless transceiver and/or a Wi-Fi transceiver, including cellular transceiver 210 and Wi-Fi transceiver 212, as described above with respect to FIG. 2.

In some embodiments, the microphone 316 may be mounted to or incorporated into camera housing 312 and is operable to capture audio of an event. The microphone 316 comprises at least one opening on a portion of camera housing 312. In embodiments of the invention, the camera housing 312 includes an input for stopping or otherwise muting the recording of audio (while still recording video). This input may be desired by some law enforcement personnel located in a jurisdiction that does not allow audio recordings of an event.

In some embodiments, camera housing 312 does not include any LEDs or other indication that the camera unit 310 is recording. For example, camera housing 312 may comprise a discrete design, such as camouflaging camera unit 310 as a nametag or other inconspicuous article, such that LEDs or other indicators would be counter to certain applications of camera unit 310. However, in further embodiments, such discretion may not be desired, and camera housing 312 may include one or more LEDs or other indicators to identify recording by the camera unit 310, and such indicators may or may not be viewable by persons other than the user of the two-piece body-worn camera 300.

As depicted in FIG. 4B, camera unit 310 may comprise a mounting assembly 330 for mounting, securing, or attaching camera unit 310. As described above, the size of camera unit 310 may vary. Further, the placement location of camera unit 310 may also vary. Accordingly, mounting assembly 330 may comprise varying configurations or designs, which may be based at least in part on the size of camera unit 310 and/or the intended placement location of camera unit 310. Further, in some embodiments, mounting assembly 330 may be permanently attached to camera unit 310. In further embodiments, mounting assembly 330 may be removably attached to camera unit 310, such that an operator may select a particular embodiment of mounting assembly 330 depending on the situation.

By way of non-limiting examples, mounting assembly 330 may comprise at least one of the following embodiments: in a first embodiment, mounting assembly 330 may be a button-mount assembly for coupling camera unit 310 to the button of the wearer's shirt; in a second embodiment, mounting assembly 330 may be a clip configured for grasping a clothing article of the user, such as an alligator clip; a third embodiment of mounting assembly may be a hook-and-loop mount (also known as Velcro®); a fourth embodiment of mounting assembly 330 may be a cradle mount; a fifth embodiment of mounting assembly 330 may be a combination of a cradle mount and a button mount; a sixth embodiment of mounting assembly 330 may be hat mount for mounting the camera unit 310 to a user's helmet, cap, or other type of hat; and a seventh embodiment of mounting assembly 330 may be a magnetic mount. It will be appreciated that the exemplary embodiments of mounting assembly 330 as provided herein are intended to be illustrative and not limiting, and mounting assembly 330 may comprise any mounting assembly for mounting a camera to a user. Further details regarding mounting assemblies can be found in U.S. Pat. No. 9,019,431, incorporated by reference herein in its entirety.

In some embodiments, camera housing 312 may comprise one or more controls, inputs, or user interface elements 340 providing an interface for a user to enter certain commands to camera unit 310. For example, in some embodiments, camera housing 312 may comprise at least a first input 342. In further embodiments, camera housing 312 may optionally and/or additionally comprise at least a second input 344. The first input may be a power on/off switch that can be actuated to a power on position, where the camera unit 310 is, in various embodiments of the invention, either (1) in a standby mode, where camera unit 310 is ready to begin capturing video upon instruction by the user; (2) in a capture mode, such that the camera unit 310 begins continuously capturing video upon actuation of the power on/off switch; or (3) in a trigger event mode, such that the system begins capturing video upon a triggering event, as described above. In some embodiments, the first input 342 may be configured as a slide switch that can be moved from an actuated position to a non-actuated position. When in an actuated position, the first input 342 may provide a visual indication to a user that the first input 342 is in the actuated position. In further embodiments, first input 342 may be configured as a button or other element for receiving user input.

In some embodiments, the second input 344 may control the active recording and marking of an event. In particular, in embodiments of the invention where the first input 342 places the camera unit 310 in standby mode, a user can quickly instruct recording by depressing or otherwise actuating the second input 344. During the recording of an event, the user can also mark the captured video. “Marking” of the captured video provides an indication of the point in time, i.e., the time when the user depresses or actuates the second input 344. The user can then quickly move to marked locations in the captured video upon viewing the video using standardized video viewing software. Marking of the captured video allows the user to identify the point in time at which a particular event in the captured video occurs. Actuation of the second input 344 thus serves as both an instruction to begin recording and to mark the captured video to identify a time or location in the captured video corresponding to actuation of the second input 344.

In some embodiments, camera unit 310 may further comprise a processor for controlling the operation of camera unit 310. For example, camera unit 310 may comprise a processor 208 as described above with respect to FIG. 2. For example, the processor 208 may monitor commands or instructions inputted through user interface elements 340 to control the video recording by instructing camera unit 310 to begin or stop recording video. Further, processor 208 may instruct storage of captured video or data on internal storage media 204. Even further, processor 208 may monitor commands, instructions, or other communication from docking unit 400 and act accordingly.

Turning to FIG. 4C, in some embodiments, camera housing 312 may further comprise one or more ports, such as port 350, which may be configured as a connection point for a cable, plug, or a connector for data communications. For example, in some embodiments, port 350 may be a USB port or other connection interface for receiving a physical connection. As described in greater detail below, through port 350, camera unit 310 may be in digital communication with docking unit 400 for transferring captured video files from camera unit 310 to docking unit 400, among other functions. Accordingly, port 350 may provide for a physical connection between camera unit 310 and docking unit 400. In further embodiments, port 350 may be substituted with a wireless transceiver, providing for a wireless method of communication. For example, camera unit 310 may comprise a wireless transceiver 250 and/or a Wi-Fi transceiver 252 as described above with respect to FIG. 2. Accordingly, camera unit 310 may be in wireless communication with docking unit 400 and/or a cloud-based storage system 280. In further embodiments, camera unit 310 may comprise a plurality of ports, such as port 350, including a combination of ports for both physical connections and wireless connections. For example, camera unit 310 may comprise a port 350 to physically connect to docking unit 400 through a connector and may also comprise a wireless transceiver 250 to wirelessly connect to docking unit 400. Accordingly, instructions or commands may be inputted through docking unit 400 and wirelessly communicated to camera unit 310, such as to begin recording video. Additionally, captured video may be transferred from camera unit 310 to docking unit 400 through the physical connection via port 350. In further embodiments, camera unit 310 may be in communication with cloud-based storage system 280 through coupling via wireless transceiver 250 and/or a Wi-Fi transceiver 252. In some embodiments, camera unit 310 may comprise a dynamic network or Wi-Fi connection, wherein camera unit 310 may be selectively in communication with cloud-based storage system 280. For example, a constant Wi-Fi or wireless communication between camera unit 310 and cloud-based storage system 280 may be taxing on the battery life of camera unit 310, causing more frequent charging or replacement of internal battery 206. Accordingly, camera unit 310 may comprise a means for selectively activating a Wi-Fi or wireless communication between camera unit 310 and cloud-based storage system 280. For example, in some embodiments, it may be advantageous to upload video directly from camera unit 310 to cloud-based storage system 280. For example, if docking unit 400 becomes damaged, it may be desirable to directly upload the video to cloud-based storage system 280.

In some embodiments, camera unit 310 may comprise one or more additional parts or components for additional features or functions to camera unit 310. For example, camera unit 310 may comprise one or more additional instances of camera 314 on camera housing 312. In some embodiments, camera unit 310 may utilize more than one instance of camera 314 to capture multiple videos of an event. For example, through multiple instances of camera 314, different angles of a single event may be captured. In further embodiments, camera housing 312 may comprise multiple instances of camera 314 aimed in multiple directions, providing for an increased viewing and video capture range. For example, camera unit 310 may comprise a front-facing instance of camera 314 and a rear-facing instance of camera 314 positioned on a wearer's body in such a manner that both the front and rear of the wearer can be captured by camera unit 310. By way of non-limiting example, camera unit 310 may be designed as a shoulder-mounted camera comprising a front-facing camera and a rear-facing camera. When activated, the camera unit 310 may capture video of events occurring both in front and behind the wearer. The captured video may be saved as either single or combined files. Metadata may be utilized to distinguish the different captured videos, providing identifying information as to which camera recorded the video. In further embodiments, docking unit 400 may also comprise an integrated instance of camera 314, and metadata may likewise be utilized to distinguish between video captured by camera unit 310 and video captured by docking unit 400.

In further embodiments, multiple instances of camera 314 may also be beneficial in 3D mapping applications. Specifically, 3D mapping techniques and software utilize multiple angles of an object for generating a 3D profile. Accordingly, in some embodiments, camera housing 312 may comprise two instances of camera 314 positioned for capturing two videos of a single object. In further embodiments, the two instances of camera 314 may comprise one instance of camera 314 on camera unit 310 and one instance of camera 314 on docking unit 400. Even further, the two instances of camera 314 may be positioned for capturing two angles of an event. After saving the video, the two video files may be analyzed and manipulated using 3D imaging software. Accordingly, in some embodiments, camera unit 310 and/or docking unit 400 may comprise additional optical components, sensors, or parts that may be required for 3D mapping.

In some embodiments, camera unit 310 may be configured for docking, attachment, or securement to docking unit 400. As described in greater detail below, in some embodiments, when in the docked position, video or other data may be transferred between camera unit 310 and docking unit 400. In further embodiments, when in the docked position, the internal battery 206 of camera unit 310 may be charged by a battery from docking unit 400. In even further embodiments, camera unit 310 may capture video even when docked to docking unit 400.

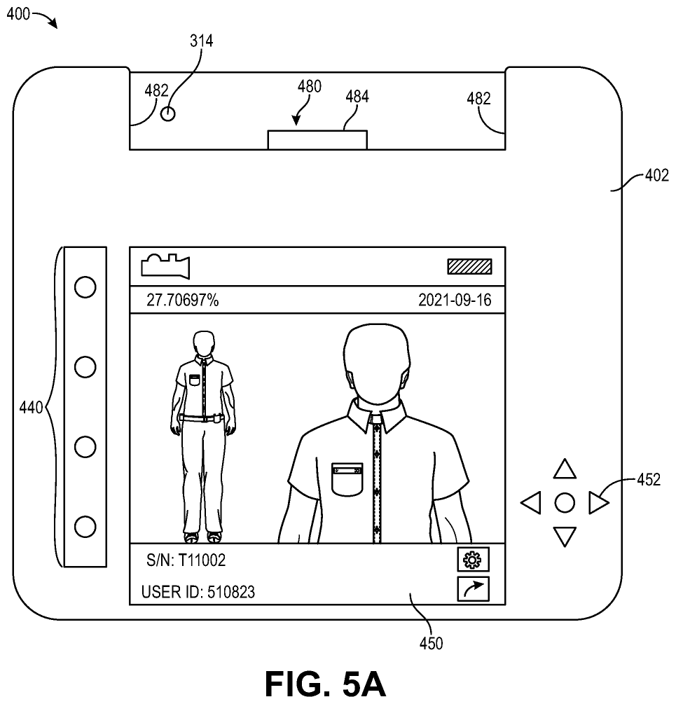

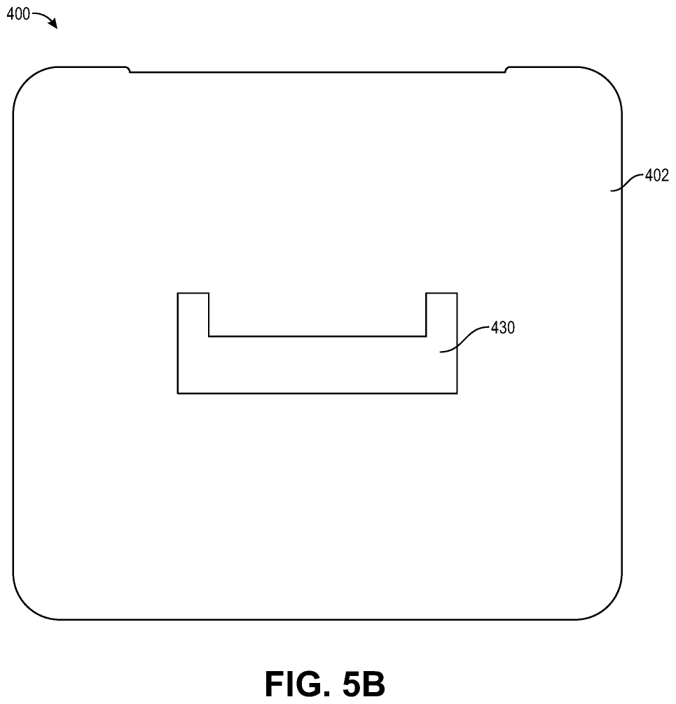

FIGS. 5A-5B depict an exemplary embodiment of a docking unit 400. As illustrated, docking unit 400 may comprise a docking unit housing 402, providing the structural body to docking unit 400 and housing one or more parts, components, circuitry, and/or features of docking unit 400. As described above, in some embodiments, camera unit 310 may be selectively docked or placed on docking unit housing 402. Accordingly, in some embodiments, docking unit housing 402 may have a size and/or dimension that is larger than the size and/or dimension of camera housing 312. For example, in certain applications, docking unit 400 may be placed on the belt, harness, or other storage location of a wearer that can adequately maintain the position of docking unit 400. Accordingly, in some embodiments, docking unit housing 402 may be designed with a form factor adapted to provide docking unit 400 with batteries, storage media, or other components with increased capabilities. In further embodiments, docking unit 400 may be designed not to be worn on a user's body and, instead, may be designed for placement in other locations. For example, in some embodiments, docking unit housing 402 may be configured for placement in a vehicle, such that a user can place (e.g., dock) camera unit 310 in docking unit 400 when driving and, upon exiting the vehicle, remove camera unit 310 for wearing. In such an embodiment, docking unit 400 may remain in the vehicle while the user (and camera unit 310) are outside the vehicle. Upon returning to the vehicle, the user can return camera unit 310 to docking unit 400 for charging or transferring video, among other actions.

In some embodiments, docking unit housing 402 may comprise a generally rectangular shape, although other shapes are contemplated. The width of the docking unit housing 402 may be approximately 1 inch to approximately 5 inches, approximately 1.5 inches to approximately 4 inches, approximately 2 inches to approximately 3 inches, or approximately 2.625 inches. The height or length of the docking unit housing 402 may be approximately 1 inch to approximately 8 inches, approximately 2 inches to approximately 7 inches, approximately 3 inches to approximately 6 inches, or approximately 4 inches. The depth of the docking unit housing 402 may be approximately 0.15 inch to approximately 1 inch, approximately 0.25 inch to approximately 0.9 inches, approximately 0.35 inch to approximately 0.785 inch, or approximately 0.625 inch. Additionally, the docking unit housing 402 weighs less than or equal to 7 ounces, less than or equal to 5 ounces, less than or equal to 4 ounces, or approximately 3.1 ounces. Like camera housing 312, the docking unit housing 402 may be made of ABS or other lightweight, durable materials and may be covered or coated with neoprene or other similar material to be soft to the touch and water resistant.

Like camera unit 310, docking unit 400 may comprise various parts or components, including but not limited to a memory element, a battery element, a transceiver, other components, or any combination thereof. For example, docking unit 400 may comprise any and all of the components described above with respect to portable dock unit 240 with reference to FIG. 2. For example, docking unit 400 may comprise at least one battery element, which may correspond to battery 246 as described above with respect to FIG. 2. In some embodiments, battery 246 may generally correspond to the size of docking unit housing 402, meaning that battery 246 may be larger in size than internal battery 206. Accordingly, in some embodiments, battery 246 may store more power than internal battery 206. The increase in stored power may be used to power certain features or aspects of docking unit 400. For example, as described in greater detail below, docking unit 400 may comprise a display. In further embodiments, battery 246 may be used to recharge or provide power to internal battery 206. For example, as described in greater detail below, docking unit 400 and camera unit 310 may be physically coupled, either through docking or other physical means. When coupled, energy may be transferred from battery 246 may be transferred to internal battery 206.

In some embodiments, docking unit 400 may comprise a storage media for the storing of recorded video. In some embodiments, the storage media may be storage media 242 as described above with respect to FIG. 2. As described in greater detail below, camera unit 310 may be coupled to docking unit 400, and when coupled, video captured from camera 314 and transferred to docking unit 400 and stored locally on storage media 242.

Like battery 246, the storage capabilities of storage media 242 may be dependent on numerous factors, such as the size of docking unit housing 402 and/or the size of storage media 242. Accordingly, internal storage media 204 may be configured with varying storage capabilities. By way of non-limiting example, internal storage media 204 may provide approximately 4 GB of storage, approximately 8 GB of storage, 16 GB of storage, approximately 32 GB of storage, approximately 64 GB of storage, approximately 128 GB of storage, approximately 256 GB of storage, approximately 512 GB of storage, or approximately 1 TB of storage.

In some embodiments, docking unit 400 may further comprise at least one transceiver for communication. For example, docking unit 400 may comprise a wireless transceiver 250 and/or a Wi-Fi transceiver 252 as described above with respect to FIG. 2. Accordingly, docking unit 400 may be in communication with a cloud-based storage system or other database for the storage of captured video or other data, including for example cloud-based storage system 280 as described above. For example, after the transfer of video or data from camera unit 310 to docking unit 400, the transferred video or data may be stored on storage media 242. Upon instruction, the video or data stored on storage media 242 may be transferred to cloud-based storage system 280. In some embodiments, a copy of the video or data may be transferred to cloud-based storage system 280, providing for a first copy that is saved on cloud-based storage system 280 and a second copy that is saved on storage media 242. In further embodiments, the video or data may be completely transferred to cloud-based storage system 280, wherein a copy of the video or data only exists on the cloud-based storage system 280. In even further embodiments, a copy of the video or data may be saved on storage media 242 until instruction for deletion or removal.

Docking unit housing 402 may comprise one or more user interface elements, such as user interface elements 440 providing an interface for a user to enter commands or instructions to docking unit 400. Similar to user interface elements 340 as described above with respect to camera unit 310, user interface elements 440 may be buttons, toggles, switches, or other communication interfaces for interaction. For example, in some embodiments, docking unit housing 402 may comprise user interface elements 440 for inputting commands to docking unit 400 to perform certain actions, such as powering on, connecting to a Wi-Fi or wireless network, and other actions. In further embodiments, docking unit housing 402 may comprise user interface elements 440 that may command or instruct actions to be performed by camera unit 310. For example, as described herein, docking unit 400 and camera unit 310 may be communicatively coupled, either through a physical connection or through a wireless connection. In some embodiments, instructions or commands entered by user interface elements 440 may be sent from docking unit 400 to camera unit 310. For example, in some embodiments, a user may instruct camera unit 310 to begin recording by entering an input via user interface elements 440. Accordingly, in some embodiments, user interface elements 440 may replace user interface elements 340. In further embodiments, user interface elements 340 and user interface elements 440 may cooperatively co-exist.

As further depicted in FIG. 5B, in some embodiments, docking unit housing 402 may comprise a mounting assembly 430 for mounting, securing, or attaching docking unit 400 to a wearer. As described above, and like camera unit 310, the size of docking unit 400 may vary. Further, the placement location of docking unit 400 may also vary. Accordingly, mounting assembly 430 may comprise varying configurations or designs, which may be based at least in part on the size of docking unit 400 and/or the intended placement location of docking unit 400. Further, in some embodiments, mounting assembly 430 may be permanently attached to docking unit 400. In further embodiments, mounting assembly 430 may be removably attached to docking unit 400, such that an operator may select a particular embodiment of mounting assembly 430, depending on the situation.

By way of non-limiting examples, mounting assembly 430 may comprise at least one of the following embodiments: in a first embodiment, mounting assembly 430 may be a button-mount assembly for coupling docking unit 400 to the button of the wearer's shirt; in a second embodiment, mounting assembly 430 may be a clip configured for grasping a clothing article or belt of the user, such as an alligator clip; a third embodiment of mounting assembly 430 may be a hook-and-loop mount (also known as Velcro®); a fourth embodiment of mounting assembly 430 may be a cradle mount; a fifth embodiment of mounting assembly 430 may be a combination of a cradle mount and a button mount; a sixth embodiment of mounting assembly 430 may be hat mount for docking unit 400 to a user's helmet, cap, or other type of hat; and a seventh embodiment of mounting assembly 430 may be a magnetic mount. It will be appreciated that the exemplary embodiments of mounting assembly 430 as provided herein are intended to be illustrative and not limiting, and mounting assembly 430 may comprise any mounting assembly for mounting a camera to a user. Further details regarding mounting assemblies can be found in U.S. Pat. No. 9,019,431, incorporated by reference herein in its entirety.

As further depicted, in some embodiments, docking unit 400 may comprise a docking bay 480 to physically couple the camera unit 310 to docking unit 400. For example, docking bay 480 may be a physical location defined in docking unit housing 402 configured for accepting camera housing 312. In some embodiments, docking bay 480 may comprise a design and dimensions generally corresponding to the shape, size, design, and/or dimensions of camera housing 312, thereby accommodating camera unit 310 when docked. For example, in the illustrated embodiment, camera housing 312 may comprise a generally rectangular design. Accordingly, docking bay 480 may also comprise a generally rectangular design to accept camera housing 312. It will be appreciated, however, that docking bay 480 may comprise any design, dimension, or shape and is not limited to the depicted embodiment.

In some embodiments, docking bay 480 may comprise engagement aids 482, which may aid in attaching and/or securing camera unit 310 to docking unit 400. For example, in the depicted embodiment, docking bay 480 may comprise a generally rectangular design that does not extend the entire width of docking unit housing 402. Further, grooves or channels may be defined in docking unit housing 402 at the boundary with docking bay 480. Accordingly, camera housing 312 may be placed into docking bay 480, engaged with engagement aids 482, and inserted along the length of the grooves.

In some embodiments, docking unit 400 may further comprise one or more instances of connector 484 for coupling docking unit 400 with camera unit 310, providing for the transfer of video files, transferring stored power, and other functions. For example, connector 484 may be configured as a male plug or connection point for engaging with a female port. For example, connector 484 may engage with port 350 of camera unit 310. However, it will be appreciated that in further embodiments, camera unit 310 may comprise a connector, and docking unit 400 may comprise a port. As depicted, in some embodiments, at least one instance of connector 484 may be located proximate to docking bay 480, such that connector 484 engages with port 350 when camera unit 310 is in the docked position. In some embodiments, camera unit 310 and docking unit 400 may be directly coupled, providing a physical connection for the transfer of video files, the transfer of input commands, and/or other digital or electronic communication. In further embodiments, the physical coupling between camera unit 310 and docking unit 400 further provides a direct connection for the transfer of power from one battery to another. In even further embodiments, the physical coupling between camera unit 310 and docking unit 400 further provides a physical connection providing a locking effect, aiding in coupling camera unit 310 and docking unit 400.

In some embodiments, docking bay 480 and docking unit 400 may further be configured to allow camera unit 310 to operate while in the docked configuration. For example, docking bay 480 may comprise a design so that when camera unit 310 is placed and secured within docking bay 480, camera 314 has an unobstructed view. Accordingly, a user may initiate a triggering event using the above-described methods to begin recording via camera unit 310 and capture video even in the docked position. When capturing video in the docked position, camera unit 310 may be powered by battery 246 instead of internal battery 206. In further embodiments, the docking bay 480 may be configured and adapted to allow camera unit 310 to operate in both a forward-facing position and a backward-facing position. For example, when docked in a forward-facing position, camera 314 of camera unit 310 can capture video and/or audio using the method described herein. When docked in a backward-facing position, camera 314 of camera unit 310 can also capture video and/or audio using the method herein. However, when docked in a backward-facing position, camera 314 of the camera unit 310 and camera 314 (when positioned in a forward-facing position) of the docking unit 400 may be used in video conferencing. For example, a police officer investigating a scene may remove the two-piece body-worn camera 300 from an attachment position on their body. When removed, the police officer may position the two-piece body-worn camera 300 such that the backward-facing instance of camera 314 of camera unit 310 is directed to the officer's face while the forward-facing instance of camera 314 of the docking unit 400 captures the scene. Further, the display 450 may also be oriented and aligned with the backward-facing instance of camera 314, allowing the officer to see third parties participating in the video conferencing.

As further depicted in FIG. 5A, in some embodiments, docking unit housing 402 may also comprise a display 450, which may provide a viewable and interactive interface for a user when using docking unit 400. For example, in some embodiments, display 450 may be display 116 as described above with respect to FIG. 1. Additionally, docking unit housing 402 may comprise one or more controls, such as controls 452 for interacting with and providing commands or instructions for interacting with display 450. For example, controls 452 may be physical buttons built into docking unit housing 402. In further embodiments, display 450 may be a touchscreen, and controls 452 may be embedded on display 450 for interaction.

Display 450 may provide to a user or operator an interface to view and/or interact with one or more features or components of two-piece body-worn camera 300. For example, in some embodiments, display 450 may provide an interface for a user to interact with and change certain settings of camera unit 310, including, by way of non-limiting example, video resolution, tint, brightness, or other capture inputs may be altered or selected. In further embodiments, other settings may be viewable and interactable through display 450. For example, a user may select different capture modes through display 450, including a video capture mode or a picture capture mode. In even further embodiments, video captured by camera unit 310 may be displayed on display 450 for viewing. In some embodiments, display 450 may be located on docking unit housing 402 on the same side as mounting assembly 430. In further embodiments, display 450 may be located on docking unit housing 402 on a different side than mounting assembly 430.

In further embodiments, docking unit housing 402 may comprise additional and/or optional components or parts, providing docking unit housing 402 with additional features or capabilities, either alone or in combination with camera unit 310. For example, in some embodiments, docking unit housing 402 may comprise at least one instance of camera 314 incorporated into or attached to docking unit housing 402, providing docking unit 400 with a video camera feature that may act independently from or in conjunction with camera unit 310. Accordingly, in some embodiments, two-piece body-worn camera 300 may capture at least two separate video feeds, with a video capture from camera unit 310 and a second video capture from docking unit 400. Through the recording of separate video feeds, multiple angles or multiple fields of view may be captured. Further, in some embodiments, the recording of multiple videos may aid in 3D mapping or 3D modeling, similar to the method described above with respect to embodiments of camera unit 310 comprising multiple instances of camera 314. In some embodiments, docking unit housing 402 may comprise a camera 314 that is always exposed and is ready for capturing video. In further embodiments, docking unit housing 402 may comprise a camera 314 that is at times covered up or is otherwise not exposed and ready for capturing video. For example, in some embodiments, docking unit housing 402 and/or docking bay 480 may comprise a design providing for a camera 314 to be integrated into docking unit housing 402, generally corresponding to docking bay 480, such that when camera housing 312 is docked in docking bay 480, the camera 314 integrated into docking unit housing 402 is covered up by camera housing 312. Further, when camera housing 312 is removed from the docked position, the camera 314 integrated into docking unit housing 402 may be exposed for capturing video.

By way of non-limiting example, a security officer or employee responsible for depositing or withdrawing money from an ATM may utilize an embodiment of two-piece body-worn camera 300 utilizing at least two instances of camera 314, with one instance of camera 314 located on camera unit 310 and another instance of camera 314 located on docking unit 400. Such security officers or employees are often at risk of attack from assailants from the rear. Continuing with this example, the employee may position camera unit 310 on the employee's chest, providing for a forward-facing capture device, and the employee may further position the docking unit 400 on the employee's belt, oriented towards the employee's back, providing for a rear-facing capture device. Accordingly, through the positioning of camera unit 310 and docking unit 400 in such a manner, video of the employee's front and back may be captured. This may be particularly advantageous in a scenario in which an assailant assaults the employee from the rear, and a forward-facing camera may not capture an image of the assailant. The video captured from docking unit 400 may be used to help identify the assailant.

Additionally, in embodiments in which multiple video feeds are captured, i.e., when both the camera unit 310 and docking unit 400 each comprise at least one instance of camera 314, the two-piece body-worn camera 300 may utilize various methods of video synchronization to synchronize the multiple video feeds that are captured. For example, in some embodiments, the two-piece body-worn camera 300 may utilize timestamp-based synchronization. When utilizing timestamp-based synchronization, processor 208 may generate timestamps obtained from a software clock stored in the internal storage media 204 for each video feed. The video feeds may then be aligned by matching the timestamps of corresponding frames. In further embodiments, the two-piece body-worn camera 300 may utilize hardware synchronization, such as frame-accurate timecode generators or genlock devices that can ensure that all instances of camera 314 capture frames at precisely the same time. In even further embodiments, two-piece body-worn camera 300 may utilize audio-based synchronization. When utilizing audio-based synchronization, audio signals may be captured along with video, and audio tracks associated with each video stream can be used as audio cues for synchronization. In even further embodiments, the two-piece body-worn camera 300 may utilize feature-based synchronization. In such embodiments, software can utilize feature extraction algorithms to identify common visual elements in the multiple video streams, which may be used as reference points to align and synchronize the video streams. It should be understood that other methods of video synchronization may be utilized, including other methods not explicitly mentioned herein or a combination of the above-referenced methods.

Accordingly, through the cooperation between camera unit 310 and docking unit 400, two-piece body-worn camera 300 may be provided with the benefits of a small form factor camera without sacrificing the functionality of a large form factor camera. Specifically, an operator may remove camera unit 310 for placement on a front shirt pocket, button, or other location on the body to capture video. Because of its small form factor, camera unit 310 may be retained in position once placed without leaning or dropping in position because of weight. Once the video is captured, a user may place (e.g., dock) camera unit 310 in docking unit 400 to transmit the captured video to cloud storage. Further, because docking unit 400 may comprise a larger form factor, docking unit 400 may comprise additional features or components, including but not limited to a graphical display, wireless transceivers, and increased storage and power capabilities.

### Use Case and Exemplary Method of Use

Turning now to FIGS. 6A-C, an exemplary use case of two-piece body-worn camera 300 is depicted. In some embodiments, a wearer may use the two-piece body-worn camera 300 to capture video, audio, pictures, or other images. For example, a patrol officer 502 may utilize two-piece body-worn camera 300 to capture video during the officer's patrol. Continuing with this example and in certain instances, it may be advantageous for a patrol officer 502 to record events during a patrol in an inconspicuous manner. Accordingly, patrol officer 502 may attach and secure camera unit 310 to body 504. Patrol officer 502 may attach camera unit 310 to various positions on body 504, with the location of placement being dependent on the size of camera unit 310. For example, in the illustrated embodiment, patrol officer 502 may secure camera unit 310 to a front shirt pocket 506 to capture video of events occurring in front of patrol officer 502. However, it should be appreciated that camera unit 310 may be attached and secured to multiple locations on body 504, such as on a hat, on a shirt button, or at other locations. When secured in place, camera unit 310 may be used by the patrol officer 502 to capture video, with the video saved locally on internal storage media 204.

In some embodiments, patrol officer 502 may optionally or additionally wish to bring docking unit 400 along during patrol. For example, patrol officer 502 may use docking unit 400 to charge the battery of camera unit 310 mid-shift, may wish to transfer video files for storage, may wish to playback captured video, or may have other reasons for bringing docking unit 400 on patrol. Accordingly, in addition to camera unit 310 secured to body 504, patrol officer 502 may also attach and secure docking unit 400 to body 504. In some embodiments, docking unit 400 may not be used as a primary video capture device, and accordingly, the placement location of docking unit 400 may be flexible. For example, law enforcement officers are oftentimes on patrol with a utility belt for holding a number of tools, such as firearms, extra magazines, pepper spray, handcuffs, and/or other items. As illustrated, in some embodiments, docking unit 400 may be attached and secured to a utility belt 508. Accordingly, docking unit 400 may be secured in place in a secure manner, allowing patrol officer 502 to perform physical activities during patrol.

As described above, camera unit 310 may be docked into docking unit housing 402. FIG. 6B depicts patrol officer 502 with a two-piece body-worn camera 300 in a docked configuration, with camera unit 310 docked in docking unit 400. For example, after capturing video through camera unit 310, patrol officer 502 may transfer the captured video from the internal storage in camera unit 310 to the internal storage of docking unit 400. Patrol officer 502 may wish to transfer video at the end of their patrol shift or at some point during the shift, particularly if patrol officer 502 wishes to upload video to cloud storage immediately after capture. Accordingly, to connect camera unit 310 to docking unit 400, patrol officer 502 may remove camera unit 310 from body 504 and place (e.g., dock) camera unit 310 in docking bay 480. Once docked, transfer of the captured video may be initiated for transferring video from camera unit 310 to docking unit 400. Once transferred, patrol officer 502 can detach camera unit 310 from docking bay 480 and return camera unit 310 to body 504. Alternatively, if patrol officer 502 does not need to capture additional video (such as at the end of a patrol), camera unit 310 may be retained in docking bay 480.

When camera unit 310 is docked, as is shown in FIG. 6B, patrol officer 502 may perform a variety of actions. For example, as outlined above, camera unit 310 may comprise a relatively small internal battery to aid in reducing the form factor of camera housing 312. Accordingly, camera unit 310 may deplete the internal battery prior to the completion of a patrol by the patrol officer 502. In some embodiments, when camera unit 310 is docked, the internal battery of docking unit 400 may charge the internal battery of camera unit 310. After a period of charging, patrol officer 502 may return camera unit 310 to body 504 to capture additional video.

In some embodiments, when camera unit 310 is docked, patrol officer 502 may initiate a transfer of captured video from camera unit 310 to docking unit 400. For example, as outlined above, camera unit 310 may capture video via camera 314 and store the video on internal storage media 204. When in the docked position, patrol officer 502 may initiate the transfer of video from camera unit 310 to docking unit 400 for storing video in storage media 242. For example, in some embodiments, patrol officer 502 may initiate transfer using user interface elements 440. In further embodiments, transfer may be automatically initiated when camera unit 310 is docked. In even further embodiments, the transfer of captured video may occur when camera unit 310 is not physically docked to docking unit 400. For example, if patrol officer 502 is in range of the Wi-Fi router, each of camera unit 310 and docking unit 400 may connect to Wi-Fi, and video may be transferred wirelessly.

In some embodiments, after the transfer of video from camera unit 310 to docking unit 400, patrol officer 502 may watch the video on docking unit 400. For example, after video is transferred and saved on storage media 242, patrol officer 502 may cause docking unit 400 to display the video on display 450. Displaying the captured video on display 450 may be particularly advantageous for several reasons. First, displaying video on display 450 may be beneficial for fidelity purposes, ensuring that camera unit 310 is properly working and capturing video. Second, displaying video on display 450 may be beneficial when interviewing witnesses in the field. Third, displaying video on display 450 may be beneficial to a patrol officer for investigating purposes, such as identifying a suspect. It will be appreciated that these examples are intended to be illustrative rather than limiting.

In some embodiments, the captured video may be transferred or otherwise sent to another storage. For example, even with the larger storage capabilities of storage media 242, it may be advantageous to transfer video files to another storage for long-term storage, including cloud-based storage system 280. When transferred, storage media 242 may be cleared, providing for additional video to be saved. In some embodiments, a confirmation message may be sent to patrol officer 502 upon successful transmission and saving of video at cloud-based storage system 280. In some embodiments, following a successful transfer and save, a confirmation message may be generated at the cloud-based storage system 280 and transferred back to two-piece body-worn camera 300. Upon receipt, the message may be provided to patrol officer 502 via display 450. In some embodiments, upon a successful transfer, patrol officer 502 may delete the copy of the video saved on storage media 242. Further, patrol officers work in shifts, and equipment may be exchanged between patrol officers during a shift change, and a single instance of two-piece body-worn camera 300 may be utilized by multiple patrol officers over a period of time. Following each shift, any video still stored on storage media 242 may be transferred to cloud-based storage system 280 and deleted from storage media 242 prior to the next use of two-piece body-worn camera 300 by another patrol officer 502.

Turning now to FIG. 6C, in some embodiments, two-piece body-worn camera 300 may optionally or additionally comprise a cable 520, which may be used to couple the camera unit 310 and docking unit 400 when camera unit 310 is detached from docking unit 400. For example, as described above and in some embodiments, camera unit 310 may comprise a relatively small battery to aid in reducing the form factor of camera unit 310. Accordingly, the duration that camera unit 310 may be powered on may not last for the duration of the shift of patrol officer 502. However, in certain situations, it may not be desirable or advantageous to remove camera unit 310 from body 504 and for docking in docking unit 400. For example, if patrol officer 502 is interviewing witnesses to an event, patrol officer 502 may not want to interrupt the interview to remove camera unit 310 for docking. Accordingly, patrol officer 502 may instead connect camera unit 310 to docking unit 400 via cable 520. When connected, the battery of camera unit 310 may be charged by the battery of docking unit 400. Further, in some embodiments, the coupling of camera unit 310 and docking unit 400 via cable 520 may also allow for the transfer of video from camera unit 310 and docking unit 400. In further embodiments, the coupling of camera unit 310 and docking unit 400 via cable 520 may also provide the exchange of commands or instructions from docking unit 400 to camera unit 310. In some embodiments, cable 520 may be inserted into port 350 of camera unit 310. Port 350 may be the same port that is engaged when camera unit 310 is docked in docking unit 400. In further embodiments, camera unit 310 may comprise a second instance of port 350 configured for cable 520. Cable 520 may further be inserted into a port (not shown) located on docking unit 400 in a similar manner. Docking unit 400 may comprise a port at any location of docking unit housing 402.

### Security Mode

In further embodiments, the two-piece body-worn camera 300 may comprise additional and/or optional features that may be selectively activated or utilized. The two-piece body-worn camera 300 may store different applications or stored instructions that, responsive to a user prompt or automatic trigger, cause the two-piece body-worn camera 300 to perform an action. In embodiments, the camera unit 310 and/or the docking unit 400 may further comprise a cellular modem or other signal-generating circuitry to send and receive wireless communications, such as the communications circuitry and hardware described above.

By way of non-limiting example, in certain situations or applications, the user of the two-piece body-worn camera 300 may be deployed in a high-risk or dangerous situation that exposes the user to physical harm or other dangers. Accordingly, in such circumstances, the two-piece body-worn camera 300 may comprise one or more features to aid in keeping the operator safe from physical harm. For example, prior to entering a high-risk area or when the operator believes that physical harm or other dangers are likely to happen, the operator may interact with user interface elements 340 of the camera unit 310 or user interface elements 440 to activate a security mode, requiring the receipt of a manual input within a time-threshold, providing an indication that the operator is safe. By way of non-limiting example, after activation of the security mode, a tactile or physical notification (such as a vibration) or an audio notification may occur following a pre-specified time period (e.g., 60 seconds). Following the notification, the user can enter an input, confirming that the operator is safe. This process can repeat, with a new notification generated after expiration of the time period (e.g., every 60 seconds) until the security mode is turned off or deactivated.

If an input confirming safety is not received within a specified threshold (such as within 10 seconds of the notification) a determination may be made that the operator is in danger or otherwise non-responsive and require aid. Following the determination or the otherwise non-receipt of an input within the time threshold following the notification, the cellular modem or other circuitry can send out an alert or other communication, providing notice to a third party that the operator may require assistance or is in harm. For example, in some embodiments, the cellular modem may reach out to 911 dispatch, police, first responders, or other emergency services and provide a pre-recorded message or other manner of communicating that the operator is in danger. In further embodiments, the cellular modem may reach out to the employer or place of business associated with the operator. In further embodiments, the cellular modem may reach out to other operators in the field, including other operators using models off the two-piece body-worn camera 300. In some embodiments, additional and/or optional details may be transmitted. For example, the location of the operator may be transmitted via GPS coordinates captured by the two-piece body-worn camera 300. In further embodiments, video captured from the camera unit 310 and/or the docking unit 400 may be transmitted. For example, in the event that a user input is not received within the threshold, the previous 5 minutes (or other time period) of audio and/or video captured by the two-piece body-worn camera 300 may be transmitted. Transmitting audio and/or video may provide contextual information about what happened to the operator. For example, in the event of an assault, the transmitted audio and/or video may aid in identifying the assailant, catalog the type and extent of injuries to the operator, and/or help identify the location of the operator. Accordingly, if the operator is hurt, incapacitated, or otherwise unable to communicate, the captured and transmitted audio and/or video can provide the information that the operator is unable to provide.

In some embodiments, the determination that the operator requires assistance may include a failsafe or other mechanism to account for situations in which the operator is unable to provide and input but is not in danger. For example, an operator exchanging money or loading an ATM with money may be engaged at the moment an input is required and unable to free their hands to make an input. Accordingly, rather than sending a security notification the first time an operator fails to enter an input within the time threshold, the process may loop, allowing the operator to enter the input during a subsequent step. The failsafe may be variable, allowing the operator to set a pre-determined limit on missed inputs prior to sending the security notification. For example, the operator may set the pre-determined limit to three consecutive missed inputs before a security notification is sent out.

### Threat Detection

In some embodiments, in addition to capturing video and/or audio for storing or transmitting, the two-piece body-worn camera 300 may comprise one or more additional/optional security features or implementations to aid in keeping the operator safe from assailants or other dangers. For example, in some embodiments, the two-piece body-worn camera 300 may incorporate one or more motion sensors or detectors to detect movement near the operator when in use. For example, during operation and if a third person comes within a pre-determined vicinity of the operator, the third party may be detected by the motion sensor and cause the two-piece body-worn camera 300 to vibrate, emit a sound, or otherwise provide a notification to the operator that someone is close by. In further embodiments, the two-piece body-worn camera 300 may be programmed with or store computer-executable instructions directed to AI detection. For example, the camera unit 310 and/or the docking unit 400 may be positioned in a backward-facing position on the operator, such as on the operator's belt. While capturing video in the backward-facing position, the two-piece body-worn camera 300 can also monitor for third parties and determine if the third parties may pose a danger or risk to the operator. For example, the AI detection software may be trained using training materials to detect and determine behaviors and actions that are predictive of violence or other threats that are about to occur. Upon detection, the two-piece body-worn camera 300 may be caused to vibrate, emit a sound, or provide another notification to the operator that a threat or danger may occur.

For example, continuing with the use case scenario described above with respect to a security officer or employee responsible for depositing or withdrawing money from an ATM, camera 314 of the rear-facing positioning of docking unit 400 can monitor for potential threats that are not visible to the operator. Upon detection of a threat or danger, the docking unit 400 may vibrate, emit a sound, or provide another notification, alerting the operator to the danger. Accordingly, not only would the would-be assailant be captured on video via the docking unit 400, but harm to the operator may be avoided entirely through the warning notification.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A two-piece body-worn video camera comprising:
a docking unit comprising:
a docking bay, a display, a first internal battery, a first internal storage media, and a transceiver,
wherein the docking unit includes a mounting assembly for mounting the docking unit to a first location on a body of a user; and
a removable camera unit having a size that is configured to mount on the body of the user, comprising:
a camera, a second internal battery, and a second internal storage media,
wherein the removable camera unit is selectively docked with the docking unit via the docking bay.

2. The two-piece body-worn video camera of claim 1, wherein the removable camera unit is configured to store video data to video the second internal storage media when not docked with the docking unit.

3. The two-piece body-worn video camera of claim 2, wherein the removable camera unit is configured to automatically transfer the video data stored on the second internal storage media to the first internal storage media when the removable camera unit is docked with the docking unit.

4. The two-piece body-worn video camera of claim 3, wherein the docking unit further comprised a wireless transceiver operable to transfer the video data via an Internet connection to cloud-based storage.

5. The two-piece body-worn video camera of claim 1, wherein the removable camera unit is configured to automatically display video data captured by the camera on the display of the docking unit when the removable camera unit is docked with the docking unit.

6. The two-piece body-worn video camera of claim 1, wherein the docking unit is configured to transfer stored energy from the first internal battery of the docking unit to the second internal battery of the removable camera unit when the removable camera unit is attached to the docking unit.

7. The two-piece body-worn video camera of claim 1, wherein the docking unit further comprised an additional camera integrated into the docking unit.

8. A two-piece body-worn camera system for recording and storing video of an event, comprising:
a docking unit comprising:
a docking bay, a first internal battery, a first internal storage media, a transceiver, and a first mounting assembly for mounting the docking unit to a first location on a body of a user,
wherein the transceiver is configured to wirelessly couple the two-piece body-worn camera system to cloud-based storage; and
a removable camera unit for capturing the video of the event, comprising:
a camera, a second internal battery unit, a second internal storage media, and a second mounting assembly for mounting the removable camera unit to a second location on the body of the user,
wherein the docking bay is configured to receive the removable camera unit,
wherein the removable camera unit is configured to transfer the video of the event from the second internal storage media of the removable camera unit to the first internal storage media of the docking unit when the removable camera unit is docked with the docking unit.

9. The two-piece body-worn camera system of claim 8, wherein the docking unit is configured to transfer the video of the event to the cloud-based storage.

10. The two-piece body-worn camera system of claim 8, wherein the video of the event comprises video data for a predetermined period of time prior to the user actuating an input to instruct recording by the two-piece body-worn camera system.

11. The two-piece body-worn camera system of claim 8, wherein the removable camera unit comprises an additional transceiver operable to wirelessly couple the removable camera unit to at least one of the docking unit or the cloud-based storage.

12. The two-piece body-worn camera system of claim 8, wherein the docking unit further comprises an additional camera for capturing additional video of the event.

13. The two-piece body-worn camera system of claim 8, wherein the removable camera unit further comprises a microphone for capturing audio.

14. The two-piece body-worn camera system of claim 8, wherein the camera is operable to record video data at a resolution of at least 1080p and at a frame rate of at least 30 frames per second.

15. A method of capturing video using a two-piece body-worn camera system, the method comprising:
responsive to detecting an actuation of an input by a user, capturing video data of an event by a camera of a removable camera unit,
wherein the removable camera unit is undocked from a docking unit when the actuation is detected,
wherein the removable camera unit and the docking unit are separately mounted on a body of the user when the actuation is detected;
storing the video data by the removable camera unit in a first internal storage medium of the removable camera unit;
responsive to detecting that the removable camera unit has been docked on the docking unit:
transferring the video data of the event to a second internal storage medium of the docking unit; and
transferring stored electrical energy from a first internal battery of the docking unit to a second internal battery of the removable camera unit; and
subsequent to the event, transferring the video from the second internal storage medium of the docking unit to cloud-based storage via a wireless network transceiver.

16. The method of claim 15, further comprising displaying the video data on a display of the docking unit during the event.

17. The method of claim 15, further comprising responsive to a determination that the video was successfully transmitted to the cloud-based storage, displaying a transfer confirmation on a display of the docking unit.

18. The method of claim 17, further comprising deleting the video data from at least one of the first internal storage medium and the second internal storage medium responsive to the determination.

19. The method of claim 15, wherein the second internal storage medium has a greater storage capacity than the first internal storage medium, and the first internal battery has greater energy capacity than the second internal battery of the removable camera unit.

20. The method of claim 15, wherein the removable camera unit is configured to continue to capture and store the video data when the removable camera unit is docked with the docking unit during the event.
